(19) United States
(12) Patent Application Publication
(10) Pub. No.: US 2007/0182365 A1
(43) Pub. Date: Aug. 9, 2007

(54) Charger with primary battery for two-way I/O

(76) Inventor: Tai-Her Yang, Si-Hu Town (TW)

Correspondence Address: RABIN & BERDO, P.C., Suite 500, 1101 14th Street, Washington, DC, 20005, US

(21) Appl. No.: 11/452,225

(22) Filed: Jun. 14, 2006

Related U.S. Application Data
(63) Continuation-in-part of application No. 11/342,697, filed on Jan. 31, 2006, now abandoned.

(51) Int. Cl. H02J 7/00

(52) U.S. Cl. 320/107

(57) ABSTRACT

A multi-purpose charger adapted with a primary battery for two-way input and output, and more particularly to a charger capable of inputting external DC power, or AC power transformed and rectified to DC power to charge a first rechargeable unit adapted to the charger or a second rechargeable unit externally provided while allowing emergency charging to the second rechargeable unit or supplying power to any other load by the first rechargeable unit.

### CROSS-REFERENCES TO RELATED APPLICATIONS

This application is a Continuation-In-Part of my patent application Ser. No. 11/342,697, filed Jan. 31, 2006.

### BACKGROUND OF THE INVENTION

(a) Field of the Invention

The present invention is related to a multi-purpose charger adapted with a primary battery for two-way input and output, and more particularly to a charger capable of inputting external DC power, or AC power transformed and rectified to DC power to charge a first rechargeable unit adapted to the charger or a second rechargeable unit externally provided while allowing emergency charging to the second rechargeable unit or supplying power to any other load by the first rechargeable unit.

(b) Description of the Prior Art

A charging source for a conventional charger usually comes from DC power rectified from AC power, or is directly supplied with the power from DC source to charge the rechargeable battery adapted to the battery holder of the charger; or alternatively, a secondary battery is adapted to the battery holder of the charger to output the source for emergency charging through a set of plug or socket. However, either of the prior arts is generally related to a stand-alone device. Economic purpose is compromised if a primary battery is externally inserted and must be disposed when consumed up; or inconvenience, more space consumed and higher costs are resulted if a rechargeable battery since a charger must be provided at the same time to charge the rechargeable battery.

### SUMMARY OF THE INVENTION

The primary purpose of the present invention is to provide a multi-purpose charger to charge a first rechargeable unit adapted to the charger or a built-in or externally provided second rechargeable unit while allowing emergency charging to the second rechargeable unit or supplying power to any other load by the first rechargeable unit.

### BRIEF DESCRIPTION OF THE DRAWINGS

FIG. 1 is a block chart showing a circuitry of the present invention.

FIG. 2 is a circuit block chart showing that the present invention charges a first rechargeable unit through a first linking interface device and charges a second rechargeable unit through a second linking interface device from an external source.

FIG. 3 is a circuit block chart showing that the first rechargeable unit of the present invention directly charges or charges the secondary rechargeable unit through a control circuit.

FIG. 4 is a circuit block chart showing that AC transformation, rectification circuit, and the second rechargeable unit are disposed at their respective casings in a first preferred embodiment of the present invention.

FIG. 5 is a circuit block chart showing that AC transformation, rectification circuit and the charger share the same first casing; the second linking interface device is independently contained in a second casing; and the second rechargeable unit is separately provided in a second preferred embodiment of the present invention.

FIG. 6 is a circuit block chart showing that AC transformation and rectification circuit, charger, the second linking interface device, and the second rechargeable unit or a load are separately provided in a third preferred embodiment yet of the present invention.

FIG. 7 is a circuit block chart showing that an external source linking interface device and the control circuit share the same casing; the first linking interface device, the first rechargeable unit, and the second linking interface device also share another same casing, and the second rechargeable unit stands alone in a fourth preferred embodiment yet of the present invention.

### DETAILED DESCRIPTION OF THE PREFERRED EMBODIMENTS

A charger adapted with a primary battery to execute two-way input and output of the present invention is essentially comprised of external source, control circuit, one or a plurality of first rechargeable unit, one or a plurality of second rechargeable unit, casing, and optional indicator.

The charger adapted with the primary battery to execute two-way input and output allows input of DC power from the external source or of AC source to be transformed and rectified into DC power to charge the first or the second rechargeable unit, and to operate the first rechargeable unit through the control circuit to charge the second rechargeable unit disposed at the battery holder of the charger, to execute emergency charging to the second rechargeable unit when externally disposed, or to supply power to another load.

Construction, operation, function and advantage of the present invention can be better understood in the following preferred embodiments and the accompany drawings.

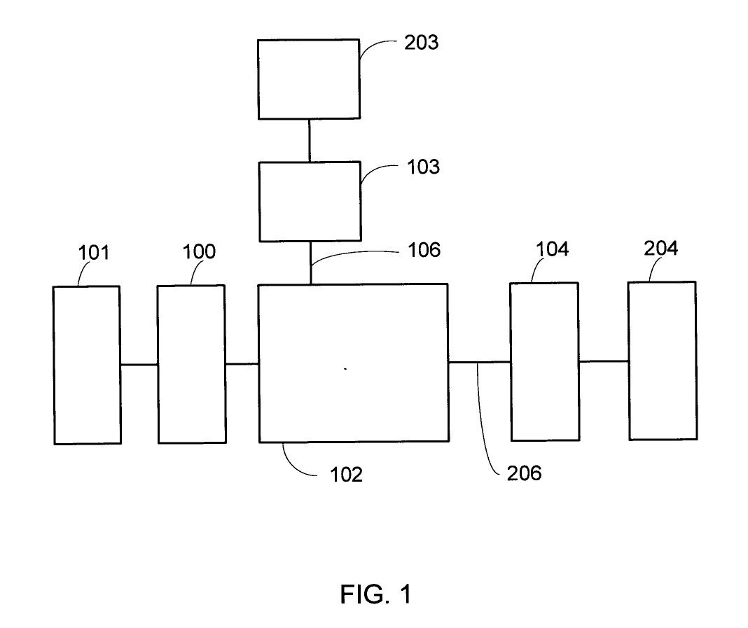

Referring to FIG. 1 for a block chart of the circuitry of the present invention, an external source of charging for the charger of the present invention adapted with two-way input and output including AC source to be transformed and rectified into DC power before or after the input into the charger, other electricity installation to output its existing AC or DC source, or electric energy supplied from a generation unit that converts wind velocity, optical, thermal, or other kinetics into electric energy as an external source 101 is essentially comprised of:
an external source linking interface device 100: related to one that is adapted to the battery holder or a socket or plug set of the casing of the charger, or one that is adapted to a battery holder or a plug or socket set linked to a conductor 106 externally extending from the casing of the charger as intended to introduce the external source 101; to this purpose, one or a plurality type and one or a plurality of those linking interface devices described above may be provided as applicable;
a control circuit 102: comprised of dynamo-electric or solid state electronic device for inputting external DC power, or external AC power to be transformed and rectified into DC power; the control circuit 102 may be disposed at one or a plurality of location as elected including (1) the charging device, (2) a first linking interface device 103, (3) a first rechargeable unit 203, (4) a second linking interface device 104, and/or (5) a second rechargeable unit 204; this control circuit 102 may be provided as applicable; for example, the control circuit 102 may not be needed if the external source 101 is given charging control function or if excellent charging match exists between the external source 101 and the voltage of the first rechargeable unit 203 or the second rechargeable unit 204; and when adapted, the control circuit 102 provides the following functions (1), (2), (3), and (4) as well as optional functions of (5), (6), and (7):

(1) To control the external source 101 in charging the first rechargeable unit;

(2) To control the external source 101 in charging the second rechargeable unit;

(3) To control the first rechargeable unit 203 in outputting power to charge the second rechargeable unit 204 or to supply power to a load;

(4) To control the external source 101 to charge both of the first rechargeable unit 203 and the second rechargeable unit 204;

(5) To control the external source 101 to supply power to a load;

(6) To control the first rechargeable unit 203 to supply power to a load; and

(7) To control any two functions of any items of (1) through (6), or functions of any two items of (1) through (6) at the same time;
the first linking interface device 103: related to one or a plurality of battery holder, plug or socket set that is disposed to the casing of the charger; or one or a plurality of battery holder, or plug or socket set linked to a conductor 106 externally extended from the casing of the charger to link the first rechargeable unit 203 and the control circuit 102;
the second linking interface device 104: related to one or a plurality of battery holder, plug or socket set that is disposed to the casing of the charger; or one or a plurality of battery holder, or plug or socket set linked to a conductor 206 externally extended through the casing of the charger to link the second rechargeable unit 204 and the control circuit 102; wherein, one or a plurality of one type or multiple types of the is battery holder or the plug or the socket set functioning as the first linking interface device 103 or the second linking interface device 104 described above may be provided as applicable;
the first rechargeable unit 203: is comprised of one or a plurality of rechargeable battery, capacitor or super capacitor directly linked to the control circuit 102, or linked to the control circuit through the first linking interface device 103 comprised of the battery holder of the casing of the charger, or the plug or socket set, or linked to the control circuit 102 through the battery holder or the plug or socket set linked to the conductor 106 externally extended from the casing of the charger; and
the second rechargeable unit 204: is comprised of one or a plurality of rechargeable battery, capacitor or super capacitor in the form of an individually provided rechargeable unit, or a rechargeable unit adapted to any type of load linked to the control circuit 102 by means of the second linking interface device 104 to input the power supplied from the external source 101 or the power supplied from the first rechargeable unit 203.

The charger adapted with a primary battery to execute two-way input and output of the present invention provides the following specific functions:

(1) The external source 101 charges one or a plurality of the first rechargeable unit 203 through the control circuit 102;

(2) The external source 101 charges one or a plurality of the second rechargeable unit 204 through the control circuit 102;

(3) The external source 101 charges the first rechargeable unit 203 and the second rechargeable unit 204 through the control circuit 102;

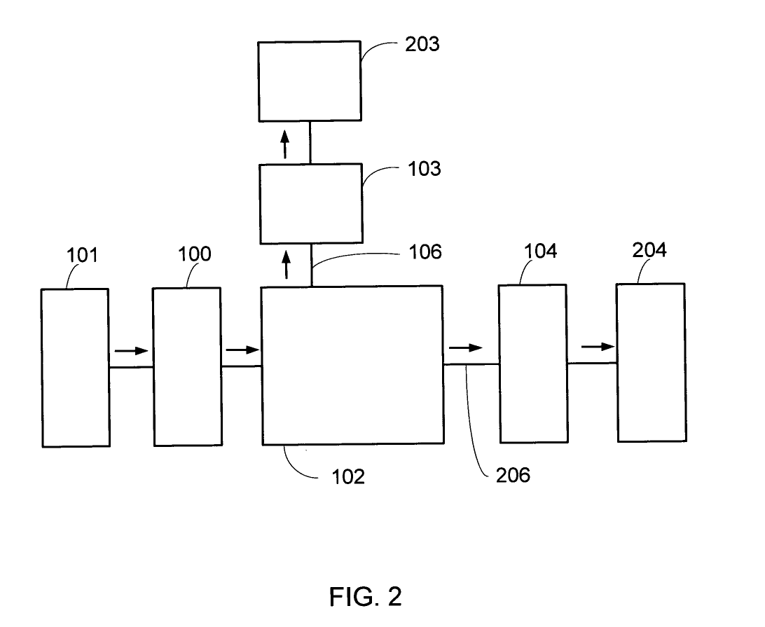

as illustrated in FIG. 2, wherein, a circuit block chart shows that the present invention charges a first rechargeable unit through a first linking interface device and charges a second rechargeable unit through a second linking interface device from an external source; and

(4) The first rechargeable unit 203 directly outputs power or outputs power through the output end of the charging source of the control circuit 102, and the power outputted directly from the first rechargeable unit 203 or through the control circuit 102 is applied to charge one or a plurality of the second rechargeable unit 204 or supply power to any other load;

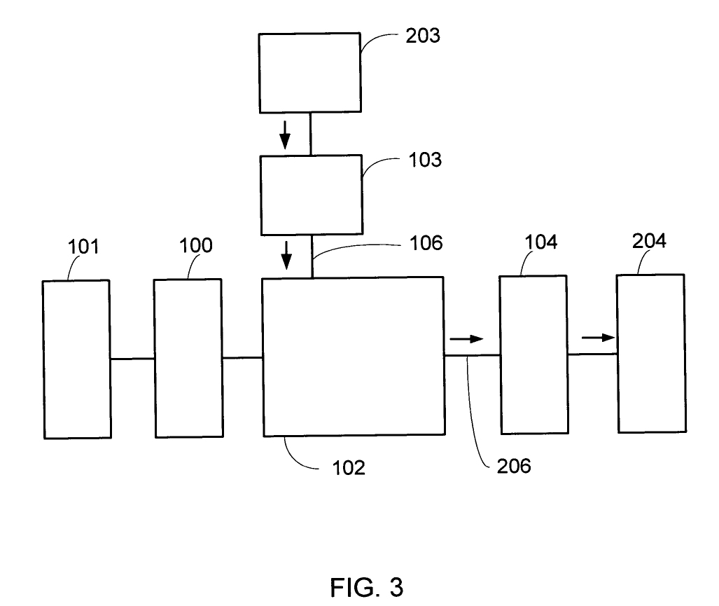

as illustrated in FIG. 3, wherein a circuit block chart shows that the first rechargeable unit of the present invention directly charges or charges the secondary rechargeable unit through a control circuit.

An alternative switch and a circuit may be further provided to the control circuit 102 of the charger adapted with the primary battery to execute two-way input and output of the present invention to select the priority of charging:

(1) When the external source 101 is applied for charging purpose, the first rechargeable unit 203 may be set at a priority over the second rechargeable unit 204 to be charged; or

(2) When the external source 101 is applied for charging purpose, the second rechargeable unit 204 may be set at a priority over the first rechargeable unit 203 to be charged; or

(3) The charging is executed at random without setting up any priority.

Without changing its innovative principles and scope of application, all associate devices of the charger of the present invention adapted with the primary battery to execute two-way input and output may be arranged such that they may be each in a separate or shared casing depending on the application. Several representative, but not inclusive preferred embodiments are given below:

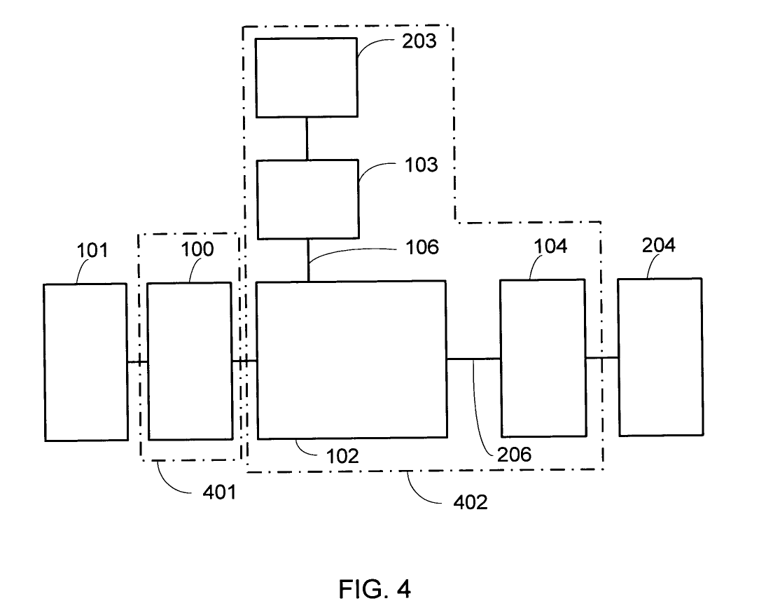

A first preferred embodiment: As illustrated in FIG. 4, AC transformation and rectification circuit, charger, and the second rechargeable unit are disposed in various casings; wherein,
a circuit device to transform and rectify the AC power inputted from an external source into DC power is disposed in a first casing 401; should the external source 101 relate to a DC source, the circuit device may not be provided; the interface device 100 linked to the external source may be provided to the first casing 401 for linking the external AC source, DC source plug, or a plug linked by means of an extension conductor;
the control circuit 102 and control circuits involved in charging source are disposed in a second casing 402 for inputting the external source 101 and controlling the output of power;
the first rechargeable unit 203 and the first linking interface device 103 are also disposed in or externally incorporated to the second casing 402 while the first rechargeable unit 203 may be directly linked to or linked to the control circuit 102 through the first linking interface device 103; and
the second linking interface device 104 is disposed in the second casing 402 or the plug or the socket set linked with an extension conductor for external output to link the second linking interface device 104 to the second rechargeable unit 204 or a load.

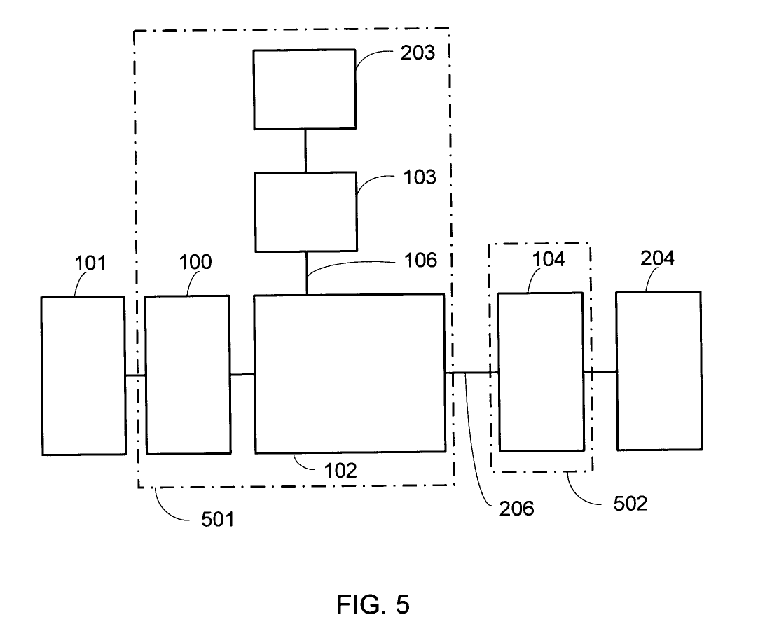

A second preferred embodiment: As illustrated in FIG. 5, the AC transformation and rectification circuit and the charger of the present invention share the same first casing while the second linking interface device is disposed in a stand-alone casing and the second rechargeable unit is separately provided essentially in a configuration described as follows:
a circuit to transform and rectify the AC power from the charging source into DC power for output, and the external source linking interface device 100 to link power plug of the AC or DC external source 101 or to link source plug linked by an extension conductor are provided in a first casing 501; those related circuit devices including the transformation and rectification circuit of the charging source may be omitted if the external source 101 relates to a DC source;
the control circuit 102 to input the power from the external source 101 and to control the output of power is also disposed in the first casing 501;
the first rechargeable unit 203 is disposed internally or externally to the first casing 501 to link the output end of the control circuit 102 directly or by means of the first linking interface device 103; and
the second linking interface device 104 is disposed to the plug or the socket set of a second casing 502, or to the output end of the control circuit 102 linked by means of an extension conductor into the first casing 501, and is further linked directly or by means of a plug or socket set to the separately provided second rechargeable unit 204 or a load.

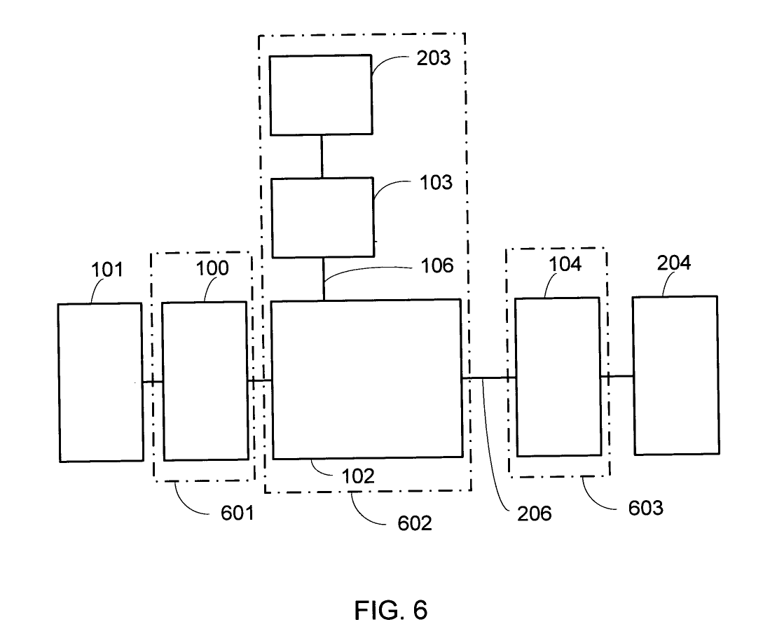

A third preferred embodiment: as illustrated in FIG. 6, the AC transformation and rectification circuit, the charger, the second linking interface device, and the second rechargeable unit or a load are separately provided is essentially comprised as follows:
the transformation and rectification circuit to convert external city power into DC power adapted with the charging source linking interface device 100 is disposed inside a first casing 601 to link a plug of external AC source or DC source, or to a power plug linked by means of an extension conductor; and if the external source 101 relates to a DC source, the first casing 601 and those related circuit devices including the transformation and rectification circuit of the charging source may be omitted;
a second casing 602 contains the control circuit 102, the first linking interface device 103, and the first rechargeable device 203; should the external source 101 relate to a DC source, the second casing 602 contains the control circuit 102, and a plug or a socket set to input the power from the external source 101, or a plug or a socket set adapted with an extension conductor;
the first rechargeable unit 203 is disposed inside or outside the second casing 602 of the charger to directly link to the control circuit 102 or link to the control circuit 102 through the first linking interface device 103;
the second linking interface device 104 is disposed to a third casing 603 containing a set of plug and socket to link to the output end of the control circuit 102 disposed in the second casing 602 or link to the control circuit 102 disposed in the second casing 602 by means of an extension conductor; the third casing 603 further contains a battery holder or another set of plug and socket, or another set of plug and socket adapted with an extension conductor for linking the separately provided second rechargeable unit 204 or load; and
a plug or a socket set, or a plug or socket set linked by means of an extension conductor is disposed at where between the first casing 601 and the second casing 602 for power transmission.

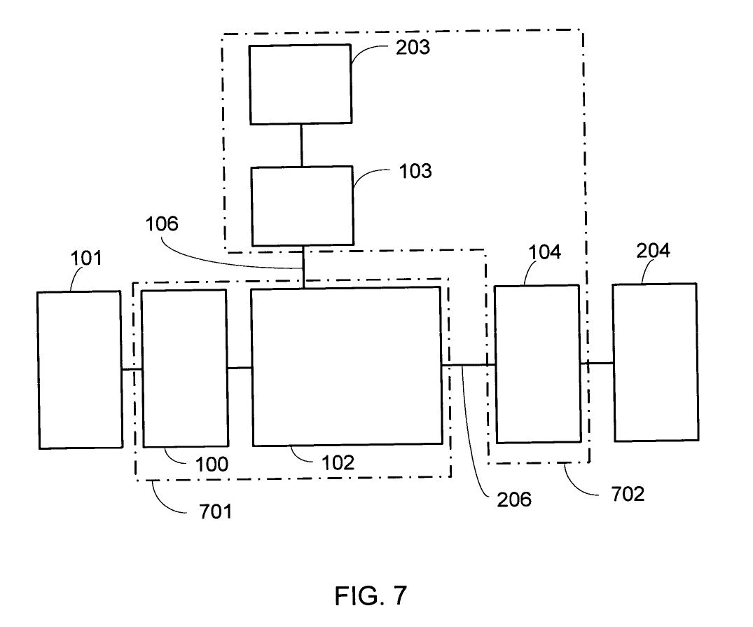

A fourth preferred embodiment: as illustrated in FIG. 7, an external source linking interface device and the control circuit share the same casing; the first linking interface device, the first rechargeable unit, and the second linking interface device also share another same casing, and the second rechargeable unit stands alone; wherein,
a first casing 701 is provided to contain a transformation and rectification circuit to convert external city power into DC power, and an interface device 100 to link the external source for further linking a plug from the external AC source or a plug of a source linked by means of an extension conductor; the first casing 701 contains also the control circuit 102 to integrate the control circuit 102 with the external source linking interface device 100;
should the external source 101 relate to a DC source, those related circuit devices including the transformation and rectification circuit of the charging source may be omitted; and the first casing 701 may contain the control circuit 102, and a plug or a socket set to input the external DC power, or a plug or socket set adapted with an extension conductor to serve as the external source linking interface device 100;
a second casing 702 is disposed to the charging device and the first rechargeable unit 203 is disposed in the second casing 702 of the charging device, or the first linking interface device 103 is comprised of a battery holder, plug and socket set, plug and socket set adapted with an extension conductor for linking to the output end of the control circuit 102;
the second linking interface device 104 comprised of battery holder or plug and socket set is also disposed in the second casing 702, and a battery holder or a plug and socket set, or a plug or a socket set adapted with an extension conductor for external output is provided to link to the independently provided second rechargeable unit 204 or a load; and
a plug or a socket set or a plug or a socket set adapted with an extension conductor is disposed between the first casing 701 and the second casing 702 for power transmission.

All those preferred embodiments illustrated in FIGS. 4, 5, 6, and 7 are not restrictive provided that they fall within the innovative principles and scope of the present invention.

Furthermore, the charger of the present invention adapted with the primary battery to execute two-way input and output may output the power as follows either by being subject to the control by the control circuit 102 or to manual control:

(1) To directly output the DC power supplied from the external source 101; or

(2) To transform and rectify AC power supplied from the external source 101 into DC power for output; or

(3) To output the power supplied from the external source 101 through the control by the control circuit 102;

(4) To output the power supplied from the first rechargeable unit 203;

(5) To output at the same time the power respectively supplied from the external source 101 and the first rechargeable unit 203;

(6) To supply power respectively from the second rechargeable unit 204 and the external source 101 at the same time to a load;

(7) To supply power respectively from the second rechargeable unit 204 and the first rechargeable unit 203 at the same time to a load;

(8) To supply power respectively from the second rechargeable unit 204, the external source 101, and the first rechargeable unit 203 at the same time to a load; or

(9) To supply the power from the second rechargeable unit 204 to a load.

The charger of the present invention adapted with a primary battery to execute two-way input and output by having an external source to charge one or a plurality of first rechargeable unit, or charge one or a plurality of second rechargeable unit, and having the first rechargeable unit to execute emergency charge or supply power to a load either directly or by means of a control circuit is innovative and provides specific functions; therefore, this application for a patent is duly filed accordingly.

1. A charger adapted with a primary battery to execute two-way input and output of the present invention including and external source, control circuit, one or a plurality of first rechargeable unit, one or a plurality of second rechargeable unit, casing, and optional indicator; the external source 101 being related to an AC source to be transformed and rectified into DC power before or after the input into the charger, other electricity installation to output its existing AC or DC source, or electric energy supplied from a generation unit that converts wind velocity, optical, thermal, or other kinetics into electric energy is essentially comprised of:
an external source linking interface device 100: related to one that is adapted to the battery holder or a socket or plug set of the casing of the charger, or one that is adapted to a battery holder or a plug or socket set linked to a conductor 106 externally extending from the casing of the charger as intended to introduce the external source 101; to this purpose, one or a plurality type and one or a plurality of those linking interface devices described above may be provided as applicable;
a control circuit 102: comprised of dynamo-electric or solid state electronic device for inputting external DC power, or external AC power to be transformed and rectified into DC power; the control circuit 102 may be disposed at one or a plurality of location as elected including (1) the charging device, (2) a first linking interface device 103, (3) a first rechargeable unit 203, (4) a second linking interface device 104, and/or (5) a second rechargeable unit 204; this control circuit 102 may be provided as applicable; for example, the control circuit 102 may not be needed if the external source 101 is given charging control function or if excellent charging match exists between the external source 101 and the voltage of the first rechargeable unit 203 or the second rechargeable unit 204; and when adapted, the control circuit 102 provides the following functions (1), (2), (3), and (4) as well as optional functions of (5), (6), and (7):
(1) to control the external source 101 in charging the first rechargeable unit;
(2) to control the external source 101 in charging the second rechargeable unit;
(3) to control the first rechargeable unit 203 in outputting power to charge the second rechargeable unit 204 or to supply power to a load;
(4) to control the external source 101 to charge both of the first rechargeable unit 203 and the second rechargeable unit 204;
(5) to control the external source 101 to supply power to a load;
(6) to control the first rechargeable unit 203 to supply power to a load; and
(7) to control any two functions of any items of (1) through (6), or functions of any two items of (1) through (6) at the same time;
the first linking interface device 103: related to one or a plurality of battery holder, plug or socket set that is disposed to the casing of the charger; or one or a plurality of battery holder, or plug or socket set linked to a conductor 106 externally extended from the casing of the charger to link the first rechargeable unit 203 and the control circuit 102;
the second linking interface device 104: related to one or a plurality of battery holder, plug or socket set that is disposed to the casing of the charger; or one or a plurality of battery holder, or plug or socket set linked to a conductor 206 externally extended through the casing of the charger to link the second rechargeable unit 204 and the control circuit 102; wherein, one or a plurality of one type or multiple types of the battery holder or the plug or the socket set functioning as the first linking interface device 103 or the second linking interface device 104 described above may be provided as applicable;
the first rechargeable unit 203: is comprised of one or a plurality of rechargeable battery, capacitor or super capacitor directly linked to the control circuit 102, or linked to the control circuit through the first linking interface device 103 comprised of the battery holder of the casing of the charger, or the plug or socket set, or linked to the control circuit 102 through the battery holder or the plug or socket set linked to the conductor 106 externally extended from the casing of the charger; and
the second rechargeable unit 204: is comprised of one or a plurality of rechargeable battery, capacitor or super capacitor in the form of an individually provided rechargeable unit, or a rechargeable unit adapted to any type of load linked to the control circuit 102 by means of the second linking interface device 104 to input the power supplied from the external source 101 or the power supplied from the first rechargeable unit 203.

2. A charger adapted with a primary battery to execute two-way input and output of claim 1, wherein, the external source 101 charges one or a plurality of the first rechargeable unit 203 through the control circuit 102.

3. A charger adapted with a primary battery to execute two-way input and output of claim 1, wherein the external source 101 charges one or a plurality of the second rechargeable unit 204 through the control circuit 102.

4. A charger adapted with a primary battery to execute two-way input and output of claim 1, wherein the external source 101 charges the first rechargeable unit 203 and the second rechargeable unit 204 through the control circuit 102.

5. A charger adapted with a primary battery to execute two-way input and output of claim 1, wherein the first rechargeable unit 203 directly outputs power or outputs power through the output end of the charging source of the control circuit 102, and the power outputted directly from the first rechargeable unit 203 or through the control circuit 102 is applied to charge one or a plurality of the second rechargeable unit 204 or supply power to any other load.

6. A charger adapted with a primary battery to execute two-way input and output of claim 1, wherein an alternative switch and a circuit may be further provided to the control circuit 102 of the charger adapted with the primary battery to execute two-way input and output of the present invention to select the priority of charging:
(1) when the external source 101 is applied for charging purpose, the first rechargeable unit 203 may be set at a priority over the second rechargeable unit 204 to be charged; or
(2) when the external source 101 is applied for charging purpose, the second rechargeable unit 204 may be set at a priority over the first rechargeable unit 203 to be charged; or
(3) the charging is executed at random without setting up any priority.

7. A charger adapted with a primary battery to execute two-way input and output of claim 1, wherein, without changing its innovative principles and scope of application, all associate devices of the charger of the present invention adapted with the primary battery to execute two-way input and output may be arranged such that they may be each in a separate or shared casing depending on the application.

8. A charger adapted with a primary battery to execute two-way input and output of claim 1, wherein the AC transformation and rectification circuit, charger, and the second rechargeable unit are disposed in various casings is essentially comprised of:
a circuit device to transform and rectify the AC power inputted from an external source into DC power is disposed in a first casing 401; should the external source 101 relate to a DC source, the circuit device may not be provided; the interface device 100 linked to the external source may be provided to the first casing 401 for linking the external AC source, DC source plug, or a plug linked by means of an extension conductor;
the control circuit 102 and control circuits involved in charging source are disposed in a second casing 402 for inputting the external source 101 and controlling the output of power;
the first rechargeable unit 203 and the first linking interface device 103 are also disposed in or externally incorporated to the second casing 402 while the first rechargeable unit 203 may be directly linked to or linked to the control circuit 102 through the first linking interface device 103; and
the second linking interface device 104 is disposed in the second casing 402 or the plug or the socket set linked with an extension conductor for external output to link the second linking interface device 104 to the second rechargeable unit 204 or a load.

9. A charger adapted with a primary battery to execute two-way input and output of claim 1, wherein the AC transformation and rectification circuit and the charger of the present invention share the same first casing while the second linking interface device is disposed in a stand-alone casing and the second rechargeable unit is separately provided, is essentially comprised of:
a circuit to transform and rectify the AC power from the charging source into DC power for output, and the external source linking interface device 100 to link power plug of the AC or DC external source 101 or to link source plug linked by an extension conductor are provided in a first casing 501; those related circuit devices including the transformation and rectification circuit of the charging source may be omitted if the external source 101 relates to a DC source;
the control circuit 102 to input the power from the external source 101 and to control the output of power is also disposed in the first casing 501;
the first rechargeable unit 203 is disposed internally or externally to the first casing 501 to link the output end of the control circuit 102 directly or by means of the first linking interface device 103; and
the second linking interface device 104 is disposed to the plug or the socket set of a second casing 502, or to the output end of the control circuit 102 linked by means of an extension conductor into the first casing 501, and is further linked directly or by means of a plug or socket set to the separately provided second rechargeable unit 204 or a load.

10. A charger adapted with a primary battery to execute two-way input and output of claim 1, wherein the AC transformation and rectification circuit, the charger, the second linking interface device, and the second rechargeable unit or a load are separately provided is essentially comprised of:
the transformation and rectification circuit to convert external city power into DC power adapted with the charging source linking interface device 100 is disposed inside a first casing 601 to link a plug of external AC source or DC source, or to a power plug linked by means of an extension conductor; and if the external source 101 relates to a DC source, the first casing 601 and those related circuit devices including the transformation and rectification circuit of the charging source may be omitted;
a second casing 602 contains the control circuit 102, the first linking interface device 103, and the first rechargeable device 203; should the external source 101 relate to a DC source, the second casing 602 contains the control circuit 102, and a plug or a socket set to input the power from the external source 101, or a plug or a socket set adapted with an extension conductor;
the first rechargeable unit 203 is disposed inside or outside the second casing 602 of the charger to directly link to the control circuit 102 or link to the control circuit 102 through the first linking interface device 103;
the second linking interface device 104 is disposed to a third casing 603 containing a set of plug and socket to link to the output end of the control circuit 102 disposed in the second casing 602 or link to the control circuit 102 disposed in the second casing 602 by means of an extension conductor; the third casing 603 further contains a battery holder or another set of plug and socket, or another set of plug and socket adapted with an extension conductor for linking the separately provided second rechargeable unit 204 or load; and
a plug or a socket set, or a plug or socket set linked by means of an extension conductor is disposed at where between the first casing 601 and the second casing 602 for power transmission.

11. A charger adapted with a primary battery to execute two-way input and output of claim 1, wherein an external source linking interface device and the control circuit share the same casing; the first linking interface device, the first rechargeable unit, and the second linking interface device also share another same casing, and the second rechargeable unit stands alone; is essentially comprised of:
a first casing 701 is provided to contain a transformation and rectification circuit to convert external city power into DC power, and an interface device 100 to link the external source for further linking a plug from the external AC source or a plug of a source linked by means of an extension conductor; the first casing 701 contains also the control circuit 102 to integrate the control circuit 102 with the external source linking interface device 100;
should the external source 101 relate to a DC source, those related circuit devices including the transformation and rectification circuit of the charging source may be omitted; and the first casing 701 may contain the control circuit 102, and a plug or a socket set to input the external DC power, or a plug or socket set adapted with an extension conductor to serve as the external source linking interface device 100;
a second casing 702 is disposed to the charging device and the first rechargeable unit 203 is disposed in the second casing 702 of the charging device, or the first linking interface device 103 is comprised of a battery holder, plug and socket set, plug and socket set adapted with an extension conductor for linking to the output end of the control circuit 102;
the second linking interface device 104 comprised of battery holder or plug and socket set is also disposed in the second casing 702, and a battery holder or a plug and socket set, or a plug or a socket set adapted with an extension conductor for external output is provided to link to the independently provided second rechargeable unit 204 or a load; and
a plug or a socket set or a plug or a socket set adapted with an extension conductor is disposed between the first casing 701 and the second casing 702 for power transmission.

12. A charger adapted with a primary battery to execute two-way input and output of claim 1, wherein the power is outputted as follows either by being subject to the control by the control circuit 102 or to manual control:
(1) to directly output the DC power supplied from the external source 101; or
(2) to transform and rectify AC power supplied from the external source 101 into DC power for output; or
(3) to output the power supplied from the external source 101 through the control by the control circuit 102;
(4) to output the power supplied from the first rechargeable unit 203;
(5) to output at the same time the power respectively supplied from the external source 101 and the first rechargeable unit 203;
(6) to supply power respectively from the second rechargeable unit 204 and the external source 101 at the same time to a load;
(7) to supply power respectively from the second rechargeable unit 204 and the first rechargeable unit 203 at the same time to a load;
(8) to supply power respectively from the second rechargeable unit 204, the external source 101, and the first rechargeable unit 203 at the same time to a load; or
(9) to supply the power from the second rechargeable unit 204 to a load.
